(19) United States
(12) Patent Application Publication
(10) Pub. No.: US 2014/0149966 A1
(43) Pub. Date: May 29, 2014

(54) APPLICATION, BUILD, INTEGRATION, AND RELEASE MANAGEMENT SYSTEM AND METHOD

(71) Applicant: INADEV CORPORATION, McLean, VA (US)

(72) Inventor: Vikrant Binjrajka, North Potomac, MD (US)

(73) Assignee: INADEV CORPORATION, McLean, VA (US)

(21) Appl. No.: 13/840,290

(22) Filed: Mar. 15, 2013

Related U.S. Application Data
(60) Provisional application No. 61/730,314, filed on Nov. 27, 2012.

(51) Int. Cl. G06F 9/44

(52) U.S. Cl. CPC G06F 8/72
USPC 717/121

(57) ABSTRACT

A system and method of building a platform specific application for a device includes receiving an input from the device and determine a platform type of the device based on the input. Source code, specific to a requested application and the platform type, is requested from a source control repository. The platform specific source code is refactored and is transmitted to a platform specific build engine. A platform specific executable is received from the build engine and is stored in an application store to make the platform specific executable available for downloading to the device.

### CLAIM FOR PRIORITY

The present application claims priority to U.S. Provisional application No. 61/730,314, filed on Nov. 27, 2012, which is incorporated by reference herein in its entirety.

### BACKGROUND

During a typical software development lifecycle, an application goes through many updates and releases from development to unit testing and from functional testing to acceptance testing. Every time there is a change, the application has to be built, released and deployed for testing. In many instances, for multiple software development environments, developers and software testers spend precious time to manually build, install and re-install the new releases of the software program on the target platforms.

### BRIEF DESCRIPTION OF DRAWINGS

The embodiments are described in detail in the following description with reference to the following figures. The figures illustrate examples of the embodiments.

FIG. 1 illustrates an application build, integration, and release management system.

FIG. 2 illustrates high-level functionality of the system of FIG. 1.

FIG. 3 illustrates extraction of source code from a source control repository and uploading refactored code to a continuous integration (CI) system of the system of FIG. 1.

FIG. 4 illustrates the transmission of platform specific code from an application management module (AMM) to a continuous integration (CI) system, and the transmission of a build, comprising platform specific executables built by the CI system, to the AMM of FIG. 1.

FIG. 5 illustrates the transmission of a list of corrected defects to the AMM of FIG. 1.

FIG. 6 illustrates the transmission of platform specific executables from the AMM to an application store of FIG. 1.

FIG. 7 illustrates a detailed description of the operation of the AMM of FIG. 1.

FIG. 8 illustrates a computer system that may be used for the methods and systems described herein.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Furthermore, the embodiments may be used together in various combinations.

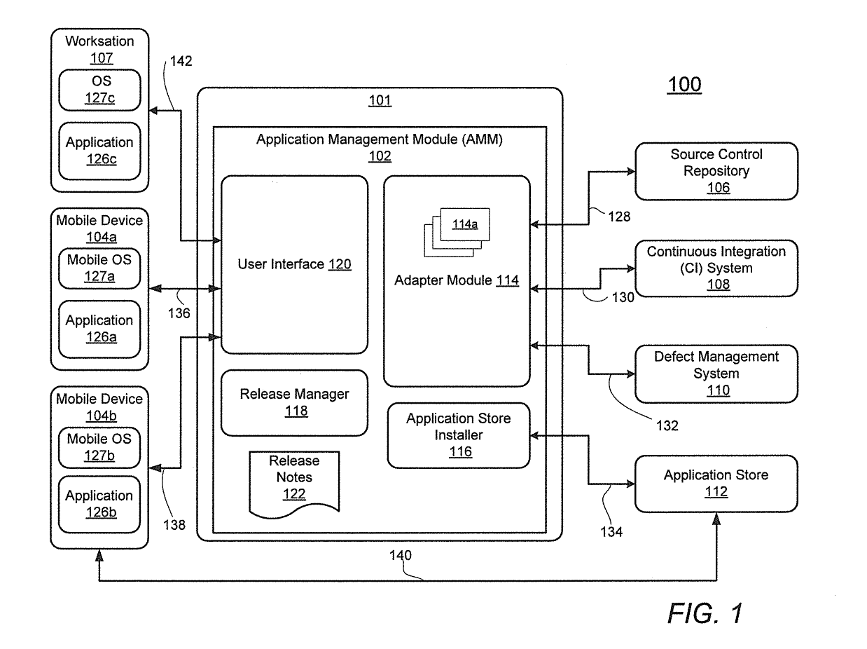

According to an embodiment, FIG. 1 illustrates an application build, integration, and release management system 100 (hereinafter “system 100”) that allows a user, e.g., a software tester, to build, release, and deploy a platform specific software application 126 on a specific computing device, including mobile devices 104a,b based on one of several mobile operating system (OS) 127a,b, as well as on tablets and workstations, e.g., workstation 107, directly connected to a telecommunications network.

A platform specific application is an application that is built to operate on a specific platform type of a particular device. For example, mobile device 104a may be built on a platform based on the ANDROID™ operating system and include mobile OS 127a. Alternatively, mobile OS 127b may include iOS™ as the operating system for mobile device 104b, wherein iOS™ is a mobile operating system developed and distributed by Apple Inc™. Other mobile platforms are also available, including for example, the mobile WINDOWS™ operating system. Although the following description primarily relates to mobile devices, the system relates equally to non-mobile devices, such as workstation 107.

In an embodiment, platform specific software application 126 is built to run on a specific platform using source code common to all platforms in addition to source code specific to the specific platform. The process of altering the internal structure of the source code specific to a specific platform and the common code, and restructuring a file and/or directory structure of the altered code to support the determined platform type, without changing the external behavior of the code, is referred to as “code refactoring.”

Throughout this application, references to “mobile device 104” will indicate any of mobile devices 104a,b and workstation 107, unless otherwise noted.

In one embodiment, the system 100 is based on a software distribution model in which applications are hosted by a vendor or service provider and made available to customers over a network, typically the Internet. In one embodiment, AMM 102 is hosted on a server 101 and may be accessed by mobile devices 104 over networks 136, 138, 140, and 142. The networks 136, 138, 140, and 142 include wireless networks including WLANS (Wireless Local Area Networks), WPANS (Wireless Personal Area Networks), WMANS (Wireless Metropolitan Area Networks), and WWANS (Wireless Wide Area Networks), as well as their non-wireless equivalents.

Mobile devices 104 and workstation 107 connect to AMM 102 to build and download an application 126. The mobile devices 104 have a Wi-Fi interface and/or a cellular interface to connect to AMM 102. The mobile devices 104 may be a cellular telephone, a computing tablet, or any mobile device that communicates with server 101. Mobile devices 104 and workstation 107 include a browser for accessing a portal on server 101 to transmit and receive data to/from AMM 102.

AMM 102 includes software modules that include machine readable instructions, e.g., software code, stored on a non-transitory computer readable medium and executed by the server 101. The software instructions implement a user interface (UI) that in one embodiment includes a graphical user interface (GUI) 120 that in combination with the browser on the mobile devices 104 and workstation 107 allows a user to download a platform specific application.

To support the refactoring of source code for different types of device platforms, AMM 102 includes an adapter module 114 that includes a plurality of adapters that includes a plurality of templates to support various combinations of mobile device types, continuous integration (CI) systems, and defect management systems. For example, to support both ANDROID™ type mobile devices and iOS™ type mobile devices, adaptor module 114 includes an adapter 114a that supports the ANDROID™ operating system and an adapter 114b that supports the iOS™ operating system. Similarly, different types of CI systems and defect management systems may have different interface requirements.

Adapter module 114 automatically determines the specific platform and OS of the mobile device 104 using an application program interface (API) that analyzes a user profile stored on the mobile device 104. Based upon the determined platform, the AMM 102 selects the appropriate adapter. In conjunction with additional information received from the user via GUI 120, the specific adapter module restructures, or refactors an existing body of code received from source control repository 106 to create device specific source code that can be used to generate a platform specific executable for the desired mobile application 126.

Source control repository 106 may be installed on a server separate from server 101 and includes a memory storage device that stores a code base that includes source code files for multiple versions of application 126 for multiple platform types and multiple release versions. The source code repository 106 includes platform specific source code for the various platforms, including mobile devices that operate based on the ANDROID™ and iOS™ operating systems and devices hardwired to a telecommunication network that are based on operating systems that include the WINDOWS™ operating system. AMM 102, hosted on computing device 101, communicates with source control repository 106 over link 128. Links, 128, 130, 132, 134, 136, 138, and 140 may be network links.

FIG. 1 further illustrates a continuous integration (CI) system 108 that communicates with AMM 102 over link 130. Adapters 114 support different types of CI systems. For example, different CI systems may be required to support both the ANDROID™ and iOS™ operating systems. Based upon predetermined settings and the determined type of device 104, a specific adapter 114 is selected that support both the selected device type and a selected CI system. CI system 108 performs software engineering functions, e.g., immediately testing and reporting changes when they are added to software repository 106. In the event that a defect is introduced into the code base, CI system 108 allows for rapid feedback of the testing in order that the defect can be identified and corrected as soon as possible.

Adapters 114 allows a user to build device specific applications on the fly based upon a collection of templates created for the different types of device 104 and the different CI systems available. For example, in one embodiment, adapter 114 populates one set of templates to refactor iOS™ specific code and common code when using one CI system, but uses another adapter 114 and another set of templates when sending the same or different refactored code to another CI system. Thus refactored code is based upon the specific device type and a specific CI system selected.

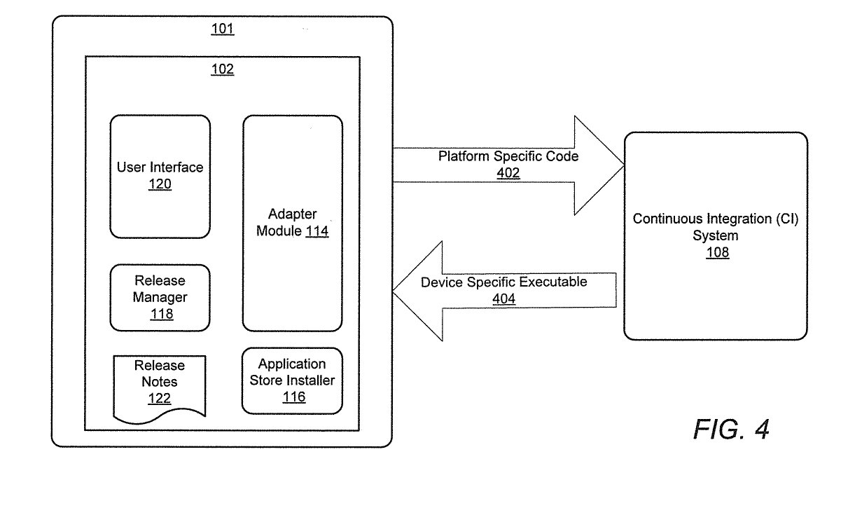

CI system 108 receives refactored code 402 (FIG. 4) from AMM 102 that is platform specific and includes a build engine for each platform type. The build engine builds a platform specific executable 404 (FIG. 4) specific to a detected mobile device 104 based upon the refactored code 402 for the specific build engine. GUI 120 allows the user to further specify the requested executable 404.

FIG. 1 further illustrates a defect management system (DMS) 110 in communication with AMM 102 over link 132. DMS 110 tracks defects and design changes, communicates with teammates, submits and reviews patches, and manages quality assurance. DMS 110 incorporates a database of problem reports and allows users or groups of developers and consultants working on same project to effectively keep track of outstanding defects in their project. Based on defects documented in DMS 110, which are corrected and documented in the source code downloaded from the source control repository 106, AMM 102 automates the testing and building of a document trail. Thus, AMM 102 details the building, testing, rebuilding, retesting, and releasing of application software executables. Similar to the use of templates to facilitate communications with a variety of CI systems, in one embodiment, AMM 102 includes a selection of templates to allow use of defect managements systems from different sources that may have different interface requirements.

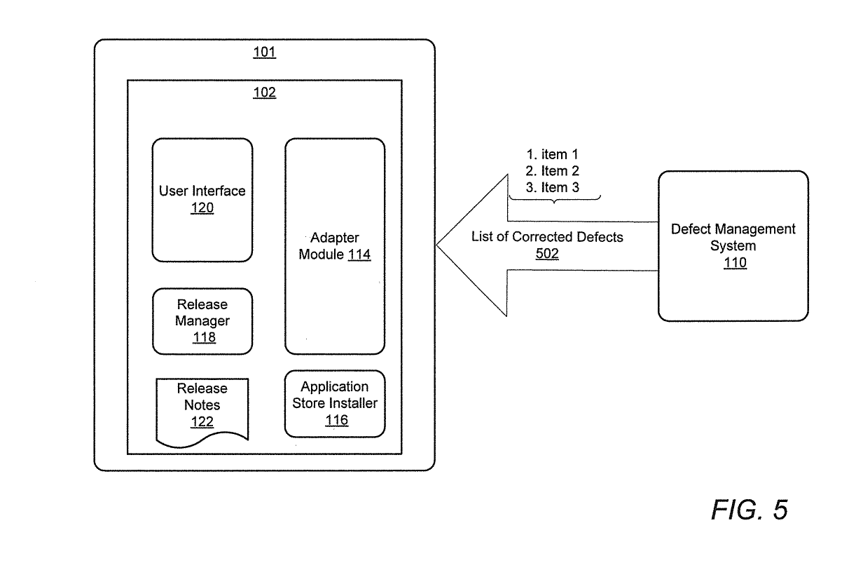

AMM 102 further includes a release manager 118 to manage and release deployments of applications, e.g., executables, including simultaneous deployments, of multiple applications on different types of mobile platforms, for example mobile devices 104a and 104b running, respectively, the ANDROID™ and iOS™ operating systems. Release manager 118 includes software code that allows a user to plan, execute, and track a software release through the lifecycle of an application. Release manager 118 further includes software code to generate release notes 122 pertaining to the generated executable, the release notes 122 based on documentation in the downloaded source code and a list of corrected defects 505 (FIG. 5) from the DMS 110.

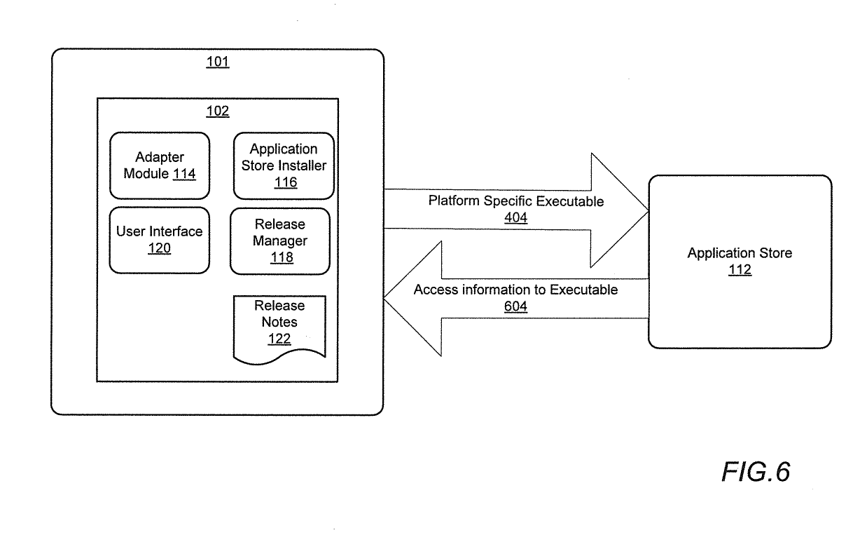

Still further, AMM 102 includes an application store installer 116 to upload the platform specific executable 404 (FIG. 6) and release notes 122 over a link 134 to a repository in an application store 112. In addition, application store 116 transmits to AMM 102 access information 604 (FIG. 6) to allow the mobile device 104 to download the stored executable 404, directly from application store 112. Thus, in one example, the access information 604 is a link to the executable 404 in the application store 112. The access information 604 may be a URL to the executable 404. A user of the mobile device may click on the link to install the executable without having to worry about whether it is the correct executable for the platform, the correct version, etc. System 100 includes a separate application store 112 for each platform type, and application installer 116 uploads the executable 404 and release notes 122 to an application store 112 specific to the platform type, e.g. OS 127a, OS 127b, of mobile devices 104a and 104b, and OS 127c of workstation 107. Thus, a user of mobile device 104a, based on an ANDROID™ platform is directed to an ANDROID™ application store and a user of mobile device 104b, based on iOS™ is directed to an iOS™ application store.

Upon uploading the platform specific executable 404 and the release notes 122 to the corresponding application store 112, a particular mobile device 104 is then allowed, under control of AMM 102, to download and install the platform specific executable 404 on at least that particular mobile device 104. Release notes 122 are accessible to a user of mobile device 102 through AMM 102.

AMM 102 allows a user, e.g., a software tester, to download, through GUI 120, the platform specific executable for application 126 to the mobile device 104 using the access information 604 supplied by the application store 112 through AMM 102. In another embodiment, AMM 102 provides the user with the access information 604 received from the application store 112. With the provided access information 604, the user is allowed to download the platform specific executable 404 directly over link 140 to the mobile device 104 without going through AMM 102.

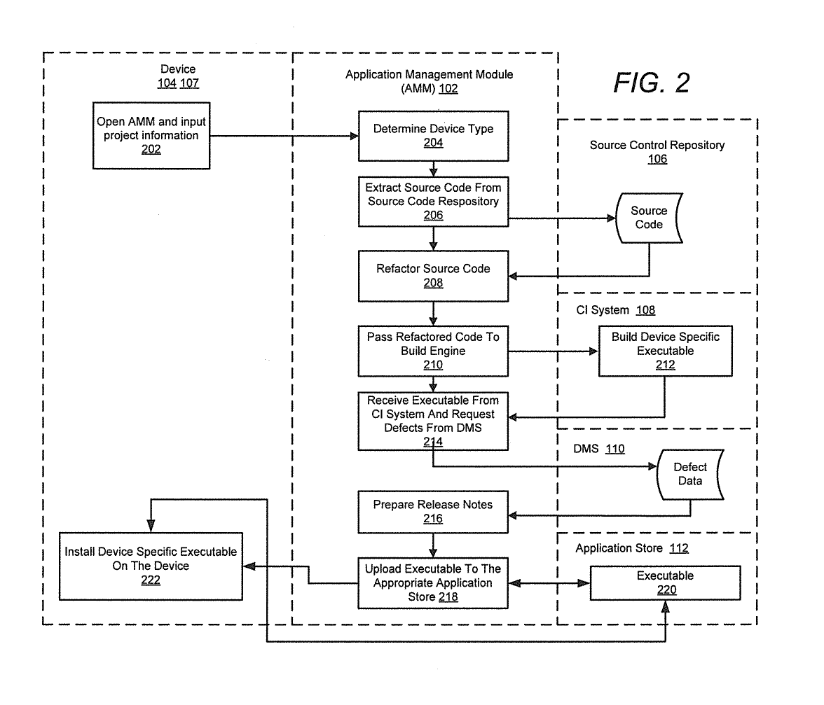

FIG. 2 illustrates a high level diagram of the functionality of the system 100. According to one embodiment, at block 202, a user, such as a tester, utilizes a browser on mobile device 104 to connect with server 101, log in to the system 100 using a username and password, and open a portal to AMM 102. AMM 102 presents the user with GUI 120 on a display portion of the mobile device 104. FIG. 2 would also apply to a user testing an application on workstation 107.

At block 204, the AMM 102 automatically detects the device type of mobile device 104, using for example, an application programming interface (API) to analyze the user profile stored on the mobile device 104 and determine the platform type. The user selects a project from a list of projects presented to the user via the GUI 120.

AMM 102 automatically extracts the latest source code files for the detected mobile device 104 from source repository 106 along with source code common to all platforms. Alternatively, or in addition, the user, via GUI 120, selects from several versions of source code stored on repository 106. In one embodiment, the source code files are stored in a file and/or directory structure in source repository 106 that is different than a structure required by a build engine on CI system 108.

At block 208, the AMM 102 refactors the extracted source code based on the detected mobile device type. Refactoring is performed by the appropriate device specific adapter of adapter module 114. More specifically, adapter module 114 takes the device specific source code files, for example, the ANDROID™ specific source code files, and common code that is common to all platform types, and restructures the extracted source code into refactored code 402 in a directory structure compatible with a specific build engine in the CI system 108.

At block 210, AMM 102 passes the refactored code 402 to a build engine in CI system 108 that is specific to the platform type of the mobile device. For example, a build engine for an ANDROID™ device, or a build engine for an iOS™ device. At block 212, CI system 108 compiles and builds an executable 404 based on the received refactored code 402 and transmits executable 404 to AMM 102.

At block 214, AMM 102 receives the built executable 404 from the CI system 108 and transmits a request for defect data from the DMS 110. The defect data includes a list of defects that includes defects that were corrected by software changes to the source code downloaded from the source control repository 106, and incorporated in executable 404.

At block 216, AMM 102 receives the requested defect data and prepares release notes 122 based on the received defect data and any fixes incorporated in the built executable.

At block 218, AMM 102 uploads the built executable 404 to the appropriate application store 112 based upon the determined mobile device 104. AMM 102 receives access information 604 from the application store 112 and forwards the access information, which in one embodiment includes a link, an address, or a URL, to the mobile device 104. Upon receipt of the access information, AMM 102 initiates a download of the executable 404 directly to the mobile device 104. Optionally, AMM 102 provides the user with the access information to allow the user to manually download the executable from the application store 112.

Regardless of which method the user downloads the platform specific executable onto mobile device 104, the mobile device 104, at block 222, installs the platform specific executable 404 onto the mobile device 104. Once installed the executable become application 126, which the user, e.g., a tester, is now able to test or otherwise operate on the mobile device 104.

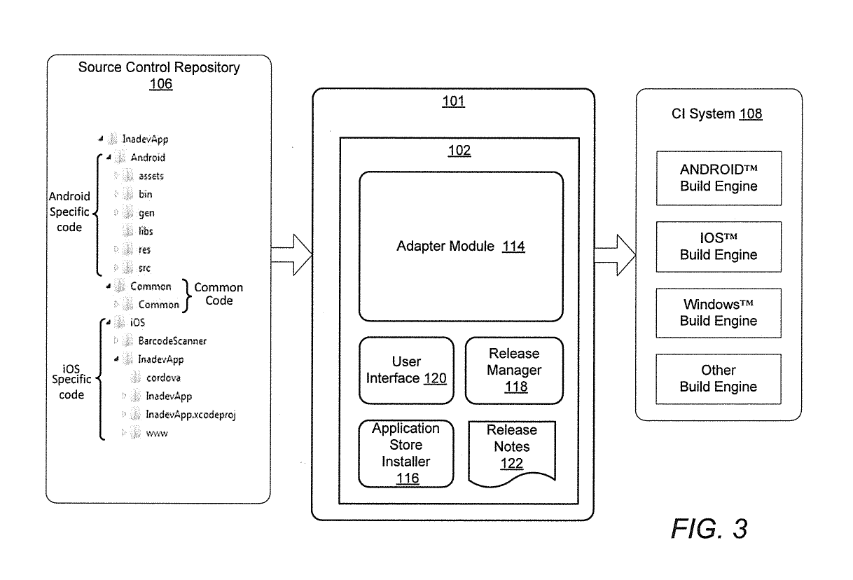

FIG. 3 illustrates one embodiment of block 206 of FIG. 2, wherein the source code repository 106 includes multiple source code files for a particular application designed to operate on multiple operating systems, e.g., ANDROID™, iOS™, WINDOWS™, and others. In one embodiment, upon determination of the type of mobile device 104, and its associated operating system, AMM 102 extracts only the common code and the source code specific to the determined type of mobile device 104. In another embodiment, AMM 102, and/or the user, via GUI 120, is able to extract any mix of source files from source repository 106.

FIG. 4 illustrates refactored platform specific source code 402 being uploaded from AMM 102 to CI system 108. The refactored source code is based upon source code pertaining to the determined type of operating system, e.g., ANDROID™, iOS™, and WINDOWS™, installed on mobile device 104, and code common to all the available operating systems. FIG. 4 further illustrates the AMM 102 receiving the platform specific executable 404, generated by a build engine in the CI system 108.

FIG. 5 illustrates the extraction of defect data from DMS 110 by AMM 102. The defect data includes a list of corrected software defects fixed by the building of platform specific executable 404.

FIG. 6 illustrates the uploading, by the application store installer 116, of the platform specific executables 404 from AMM 102 to application store 112. The platform specific executables 404 are uploaded to an application store 112 specific to the determined mobile device type. Upon uploading of the platform specific executable 404, the application store 112 returns access information 604 to AMM 102 indicating a location of executable 404. Release notes 122 are loaded into the application store 112 along with the executable 404.

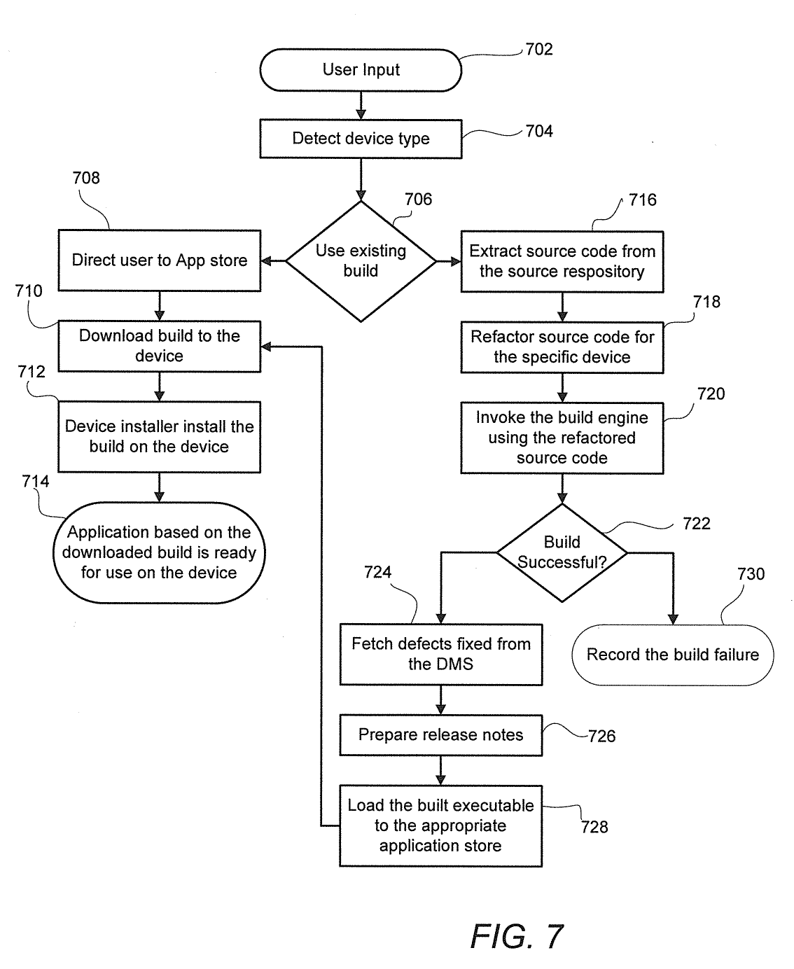

FIG. 7 illustrates a method, according to an embodiment, to implement the high-level functional flowchart of FIG. 2 and FIGS. 3-6. Reference is made to components illustrated in FIGS. 1-6 and described above.

At 702, a user of mobile device 104 accesses an AMM 102 hosted on a server 101 via the Internet. At 704, AMM 102 determines the mobile device type, i.e., platform type. At 706, using GUI 120, the user determines whether to download an existing executable or to create a new executable. Upon determining to download an existing executable, at 708, the AMM 102 directs the user to the appropriate application store 112 and provides mobile device 104 with the appropriate access 604 to the requested executable. In the event that the device type is unknown, the user may select a specific executable from a list of preexisting and available executables. Each executable is associated with a link to a specific executable in a specific application store 112.

At 710, either automatically or under control of the user, AMM 102 accesses the appropriate stored executable and causes the application store 112 to download the appropriate executable to the mobile device 104. At 712, a device installer resident on mobile device 104 is responsible for installing the executable on the mobile device 104. At 714, the device specific application 126 installed from the downloaded executable is ready for use on the mobile device 104.

If, at step 706, the user decides to create and download a new executable onto mobile device 104, AMM 102 extracts (716) source code from source repository 106 based on the determined type of mobile device 104 as well as on information provided by the user via GUI 120. GUI 120 provides a list of selectable projects and/or release dates. Each source code version may have associated with it a unique identification (ID) that corresponds to a source code component stored in repository 106.

At 718, AMM 102 refactors source code 402, and at 720, invokes a platform specific build engine of CI system 108 over link 130 to build the platform specific executable 404.

At 722 the AMM 102 determines whether the build was successful, and if successful, retrieves the built executable 404 and, at 724, fetches, based upon corrected defect information in the source code, a list of corrected defects 502, from the DMS 110 over link 134. If the build was unsuccessful, the AMM 102 records the build failure at 730.

At 726, the release manager 118 prepares release notes 122 based on the list 502 received from DMS 110.

At 728, application store installer 116 installs over link 134 executable 404 in an application store 112 specific to the determined platform type of mobile device 104. Upon installation, application store installer 116 receives a link to the installed executable.

The method then continues at block 710, described above, in which the user accesses the appropriate stored executable and causes the application store 112 to download the executable to the specific mobile device, e.g., mobile device 104.

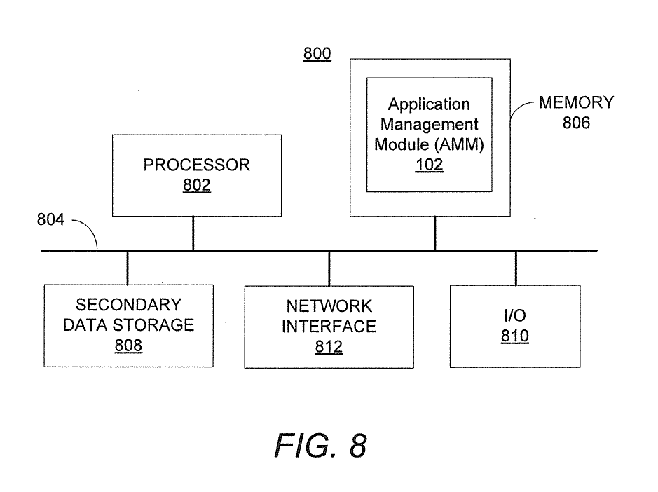

FIG. 8 illustrates one embodiment of computer system 800 that may be used with the embodiments described herein including the application management system 102. The computer system 800 represents a generic platform that includes components that may be in a server or another computer system. The computer system 800 may be used as a platform to run source control repository 106, the CI system 108, the DMS 110, the application store 112, and the AMM 102 for system 100. The computer system 800 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 800 includes at least one processor 802 that may implement or execute machine readable instructions performing some or all of the methods, functions and other processes described herein. Commands and data from the processor 802 are communicated over a communication bus 804. The computer system 800 also includes a main memory 806, such as a random access memory (RAM), where the machine readable instructions and data for the processor 802 may reside during runtime, and secondary data storage 808, which may be non-volatile and stores machine readable instructions and data used by system 800.

For example, the AMM 102 may comprise machine readable instructions that reside in the memory 806 during runtime, and secondary data storage 808 may comprise output of source control repository 106, CI system 108, and defect management system 110. Other components of the systems described herein may likewise be embodied as machine readable instructions stored in the memory 806 during runtime. The memory 806 and data storage are examples of non-volatile computer readable mediums.

The computer system 800 may include an I/O device 810, such as a keyboard, a mouse, a display, etc. The computer system 800 may include a network interface 812 for connecting to a network. The AMM 102 may receive user input from mobile device 104 and source code from source control repository 106. AMM 102 may also transmit and receive data from CI system 108, defect management system 110, and application store 112 via a network using network interface 812. Other known electronic components may be added or substituted in the computer system 800. In other words, system 100 may be implemented in a distributed computing environment, such as a cloud system, and use thereof may be based on a subscriber as a service model.

While the embodiments have been described with reference to examples, various modifications to the described embodiments may be made without departing from the scope of the claimed embodiments.

What is claimed is:

1. A method of building a platform specific application for a device, comprising:
receiving an input from the device and determining based on the input, a platform type, of a plurality of platform types, of the device;
receiving, from a source control repository, source code specific to a requested application and the determined platform type of the device;
refactoring the source code specific to the platform type of the device based upon the platform type of the device;
transmitting the refactored source code to a platform specific build engine;
receiving from the platform specific build engine a platform specific executable; and
storing the platform specific executable in an application store to make the platform specific executable available for downloading to the device.

2. The method of claim 1, wherein the plurality of platform types includes ANDROID™ and iOS™ operating systems.

3. The method of claim 1, wherein receiving an input from the device further includes receiving an input indicating source code to receive from the source control repository.

4. The method of claim 1, wherein receiving the platform specific executable from the platform specific build engine further includes receiving and storing a list of defects corrected by the executable.

5. The method of claim 4, further comprising generating and storing release information pertaining to the platform specific executable.

6. The method of claim 1, further comprising downloading the platform specific executable from the application store to the mobile device.

7. An application lifecycle management system, comprising:
a data processing device; and
a memory on which is stored machine readable instructions, that when executed by the data processing device cause the data processing device to:
receive an input from a device and determine a platform type, of a plurality of platform types, of the device based on the input;
receive, from a source control repository, source code specific to a requested application and the determined platform type of the device;
refactor the source code received from the source control repository based upon the determined platform type;
transmit the refactored source code to a platform specific build engine;
receive from the platform specific build engine a platform specific executable; and
store the platform specific executable in an application store to make the platform specific executable available for downloading to the device.

8. The system of claim 7, wherein the plurality of platform types includes ANDROID™ and iOS™ operating systems.

9. The system of claim 7, wherein to receive an input from the device further includes to receive an input indicating source code to receive from the source control repository.

10. The system of claim 7, wherein to receive the platform specific executable from the platform specific build engine further includes to receive and store a list of defects corrected by the executable.

11. The system of claim 7, wherein the data processing device is generate and storing release information pertaining to the platform specific executable.

12. The system of claim 7, wherein the data processing device is to download the platform specific executable from the application store to the mobile device.

13. A non-transitory machine-readable medium comprising instructions that when executed by a data processing device, cause the data processing device to:
receive an input from a device and determine a platform type, of a plurality of platform types, of the device based on the input;
receive, from a source control repository, source code specific to a requested application and the determined platform type of the device;
refactor the source code received from the source control repository based upon the determined platform type;
transmit the refactored source code to a platform specific build engine;
receive from the platform specific build engine a platform specific executable; and
store the platform specific executable in an application store to make the platform specific executable available for downloading to the device.

14. The non-transitory machine-readable medium of claim 13, wherein the plurality of platform types includes ANDROID™ and iOS™ operating systems.

15. The non-transitory machine-readable medium of claim 13, wherein to receive an input from the device further includes to receive an input indicating source code to receive from the source control repository.

16. The non-transitory machine-readable medium of claim 13, wherein to receive the platform specific executable from the platform specific build engine further includes to receive and store a list of defects corrected by the executable.

17. The non-transitory machine-readable medium of claim 13, wherein the data processing device is to generate and store release notes pertaining to the platform specific executable.

18. The non-transitory machine-readable medium of claim 13, wherein the data processing device is to download the platform specific executable from the application store to the mobile device.

19. The method of claim 1, wherein refactoring the source code includes populating a refactoring template of a plurality of refactoring templates based upon the source code specific to the platform type of the device and the platform specific build engine.

20. The system of claim 7, further comprising a plurality of refactoring templates, wherein the data processing device is to populate a selected refactoring template of the plurality of refactoring templates in response to the determined source code specific to the requested application and the determined platform type of the device and the platform specific build engine.
